(19) United States
(12) Patent Application Publication
(10) Pub. No.: US 2011/0033114 A1
(43) Pub. Date: Feb. 10, 2011

(54) IMAGE PROCESSING APPARATUS AND COMPUTER READABLE MEDIUM

(75) Inventor: Yuya KONNO, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/851,934

(22) Filed: Aug. 6, 2010

(30) Foreign Application Priority Data
Aug. 10, 2009 (JP) 2009-185431
Jun. 7, 2010 (JP) 2010-129619

(51) Int. Cl. G06K 9/46

(52) U.S. Cl. 382/190

(57) ABSTRACT

An image processing apparatus includes: a document accepting section that accepts a document having pieces of character information and character images in mixture; a character information extracting section that extracts the pieces of character information from the accepted document; a character image extracting section that extracts the character images from the accepted document; recognizing the character images; a character recognition control section that performs a control so as to cause the character recognition section to recognize an extracted character image by using pieces of character information that are located in the vicinity of said extracted character image; and a document shaping section that shapes the document on the basis of the extracted pieces of character information and character recognition results of the character recognition section.

### CROSS-REFERENCE TO RELATED APPLICATIONS

This application is based on and claims priority under 35 USC 119 from Japanese Patent Application Nos. 2009-185431 filed on Aug. 10, 2009 and 2010-129619 filed on Jun. 7, 2010.

### BACKGROUND

### Technical Field

The present invention relates to an image processing apparatus and a computer readable medium.

### SUMMARY

According to an aspect of the invention, an image processing apparatus includes: a document accepting section that accepts a document having pieces of character information and character images in mixture; a character information extracting section that extracts the pieces of character information from the document accepted by the document accepting section; a character image extracting section that extracts the character images from the document accepted by the document accepting section; a character recognition section that recognizes the character images; a character recognition control section that performs a control so as to cause the character recognition section to recognize a character image extracted by the character image extracting section by using pieces of character information that are located in the vicinity of said character image; and a document shaping section that shapes the document on the basis of the pieces of character information extracted by the character information extracting section and character recognition results of the character recognition section.

### BRIEF DESCRIPTION OF THE DRAWINGS

Exemplary embodiment(s) of the present invention will be described in detail based on the following figures, wherein:

FIG. 1 is a conceptual module configuration diagram showing an example configuration of a first exemplary embodiment;

FIGS. 2A-2D illustrate various example forms of a document;

FIG. 3 illustrates a character code information table (example data structure);

FIG. 4 illustrates a buried character style information table (example data structure);

FIG. 5 illustrates a character image table (example data structure);

FIG. 6 illustrates an example morphological analysis result;

FIGS. 7A-7C illustrate example character images with connection character codes;

FIGS. 8A-8C illustrate example character image strings each of which is generated after the connection character codes are converted into character images;

FIG. 9 is a flowchart of an example process according to the first exemplary embodiment;

FIG. 10 is a conceptual modular configuration diagram showing an example configuration of a second exemplary embodiment;

FIGS. 11A-11D illustrate various example forms of a document;

FIG. 12 illustrates a buried character style information table (example data structure);

FIG. 13 illustrates a character image table (example data structure);

FIGS. 14A and 14B illustrate an example of presentation of a subject document and an example word separation result, respectively;

FIG. 15 is a flowchart of part of an example process according to the second exemplary embodiment;

FIG. 16 is a flowchart of the other part of the example process according to the second exemplary embodiment;

FIGS. 17A-17F illustrate a specific example operation performed in the second exemplary embodiment; and

FIG. 18 is a block diagram showing an example hardware configuration of a computer as an implementation of the first or second exemplary embodiment.

### DETAILED DESCRIPTION

Exemplary embodiments of the present invention will be hereinafter described with reference to the drawings.

### First Exemplary Embodiment

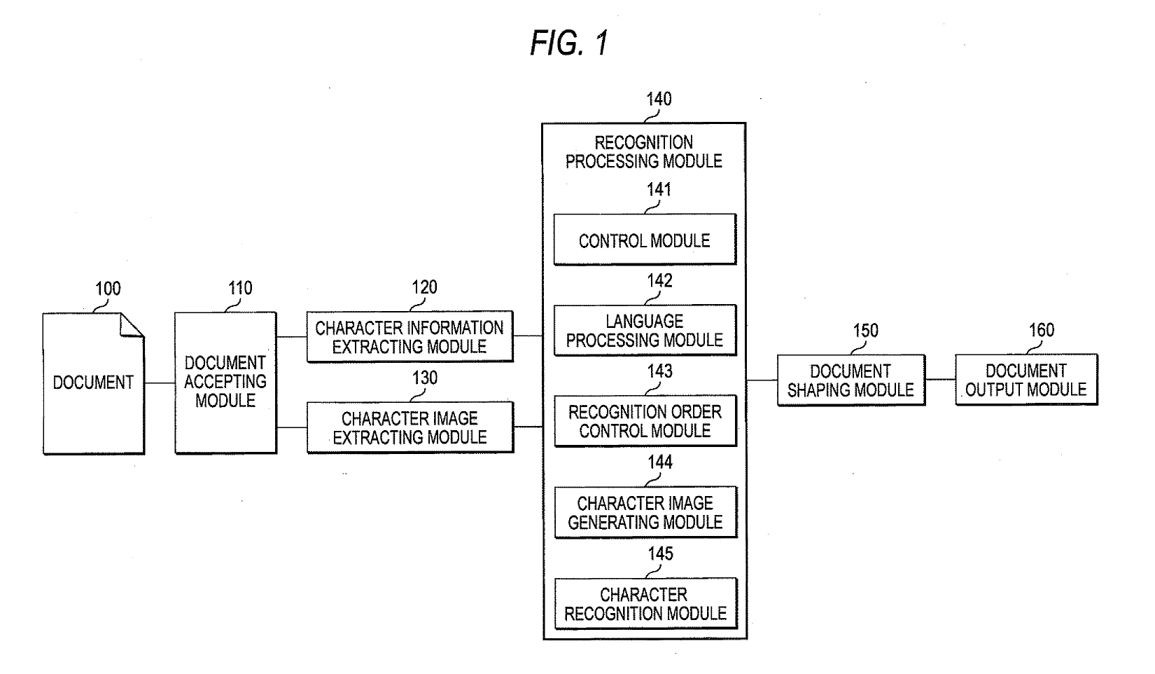

FIG. 1 is a conceptual module configuration diagram showing an example configuration of the first exemplary embodiment.

The term “module” means a software (computer program) component, a hardware component, or the like that is generally considered logically separable. Therefore, the term “module” as used in the exemplary embodiment means not only a module of a computer program but also a module of a hardware configuration. As such, the exemplary embodiment is a description of a computer program, a system, and a method. For convenience of description, the term “to store” and terms equivalent to it will be used. Where the exemplary embodiment is intended to be a computer program, these terms mean storing information in a storage device or performing a control so that information is stored in a storage device. Modules may correspond to functions one to one. In implementations, one module may be formed by one program. And plural modules may be formed by one program and vice versa. Plural modules may be executed by one computer, and one module may be executed by plural computers in a distributed or parallel environment. One module may include another module. In the following description, the term “connection” is used for referring to not only physical connection but also logical connection (e.g., data exchange, commanding, and a referencing relationship between data).

The term “system or apparatus” includes not only a configuration in which plural computers, pieces of hardware, devices, etc. are connected to each other by a communication means such as a network (including a one-to-one communication connection) but also what is implemented by a single (piece of) computer, hardware, device, or the like. The terms “apparatus” and “system” are used so as to be synonymous with each other. The term “predetermined” means that the item modified by this term was determined before a time point of processing concerned (i.e., before a start of processing of the exemplary embodiment), and also means that the item modified by this term is determined before a time point of processing concerned according to a current or past situation or state even in the case where the item modified by this term is determined after a start of processing of the exemplary embodiment.

As shown in FIG. 1, an image processing apparatus according to the first exemplary embodiment, which serves to recognize character images of a document which has pieces of character information and character images in mixture, is equipped with a document accepting module 110, a character information extracting module 120, a character image extracting module 130, a recognition processing module 140, a document shaping module 150, and a document output module 160.

The document accepting module 110, which is connected to the character information extracting module 120 and the character image extracting module 130, accepts a document 100 having pieces of character information and character images in mixture and passes the accepted document 100 to the character information extracting module 120 and the character image extracting module 130. The term “to accept a document” includes reading a document that is stored in a hard disk drive (including one built in a computer and one connected via a network), for example. A document 100 to be accepted may have either a single page or plural pages.

Although the language of characters written in a document 100 may be any language, the first exemplary embodiment is particularly suitable for two-byte-code languages (e.g., Japanese, Chinese, and Korean) because each of these languages has many kinds of characters and hence only restricted environments can prepare character images corresponding to all character codes of the language. In this case, it is attempted to incorporate, in a document 100, in advance, character images of characters that, in general, cannot be displayed. Therefore, there may occur a document 100 having pieces of character information and character images in mixture. The following description will be mainly directed to a case of Japanese.

A document 100 to be accepted by the document accepting module 110 has pieces of character information and character images in mixture. That is, a document 100 contains character codes that are parts of pieces of character information and character images that are known to be characters but cannot be handled as character codes. A document 100 may be such as to have electronic data of images other than character images, a moving image, audio, or the like or electronic data of a combination from them, to become a subject of storage, editing, a search, etc., and to be able to be exchanged between systems or users as an exchange unit. A document 100 may be one similar to such a document 100. For example, a document in document description language, more specifically a PDF (portable document format) document is applied as a document 100. A document 100 may also be a business document, a brochure for advertisement, or the like.

A piece of character information may contain, in addition to a character code, such information as a character size, a position (coordinates) in a document in the case where the character is to be displayed, and a font. The term “character image” means an image of a displayed character image (rasterized image) and may be either an image of a single character or plural characters. A character image may contain, in addition to an image, such information as a position (coordinates) in a document in the case where the character is to be displayed. However, no character code corresponds to each character image of a document 100 to be accepted by the document accepting module 110.

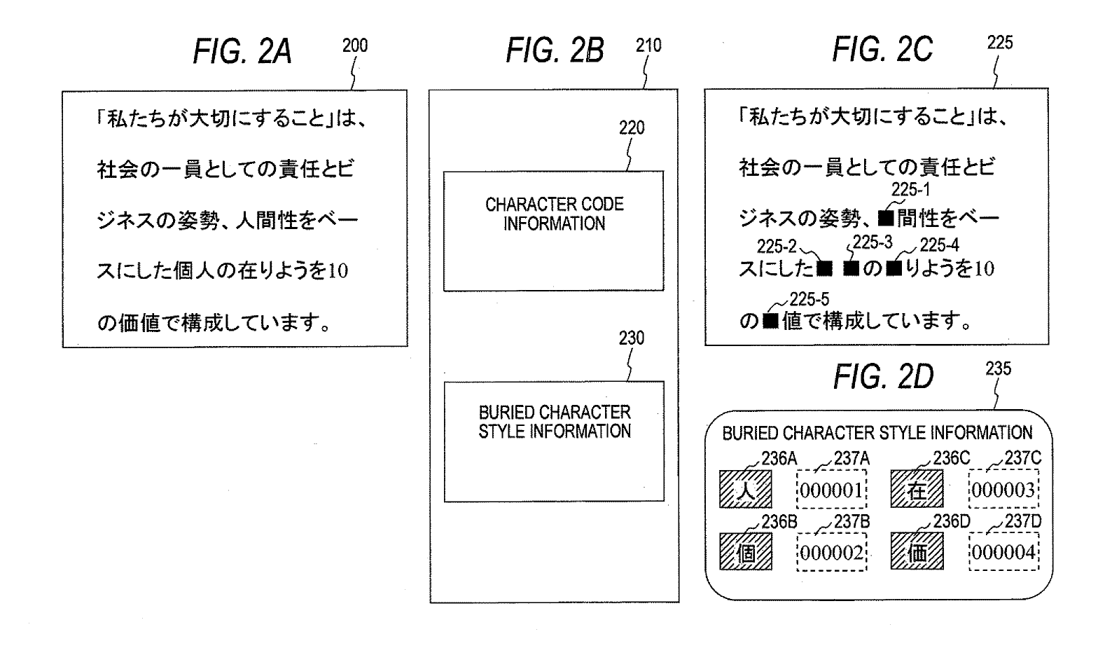

FIGS. 2A-2D illustrate various example forms of a document 100.

FIG. 2A shows an example presentation document 200 which is the document 100 that is displayed on a display device or the like or printed on a medium such as a sheet of paper. Although only characters appear in the presentation document 200, its original data contains not only character codes (character information) but also character images.

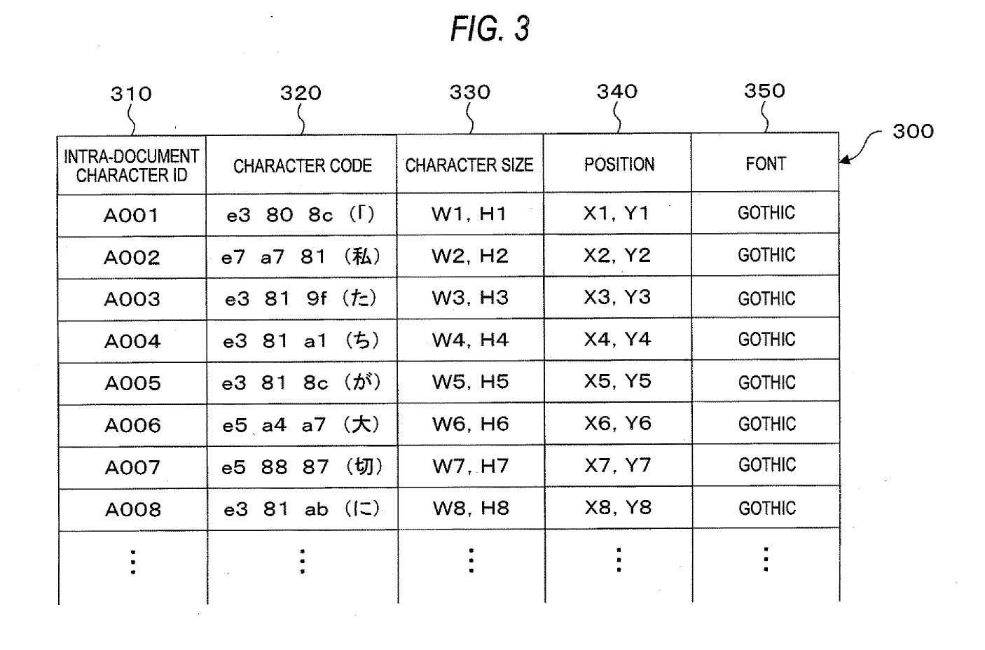

FIG. 2B shows example main data of the document 100. Intra-document data 210 consists of character code information 220 (pieces of character information) and buried character style information 230 (character images). An example data structure of the character code information 220 is a character code information table 300 which is illustrated in FIG. 3.

The character code information table 300 has an intra-document character ID column 310, a character code column 320, a character size column 330, a position column 340, and a font column 350.

The intra-document character ID column 310 contains intra-document character IDs (identifiers). The intra-document character ID is a code for uniquely identifying a character existing in a document.

The character code column 320 contains character codes used for information exchange. In the example of FIG. 3, hexadecimal representations of character codes of UTF-8 are shown in the character code column 320 (characters are shown in parentheses). The character code is not limited to UTF-8. JIS code and EUC may be employed.

The character size column 330 contains character sizes of the characters in the document. Although in the example of FIG. 3 the character size is a combination of the numbers of pixels in the width direction and the height direction, it may be the number of points or the like.

The position column 340 contains positions of the characters in the document. In the example of FIG. 3, they are sets of X and Y coordinates having the top-left corner of the document as the origin.

The font column 350 contains fonts to which the respective characters belong.

FIG. 2C shows presentation character codes 225 that are the character code information 220 that is displayed on a display device or printed on a medium such as a sheet of paper. Among the presentation character codes 225, ones that appear as characters have character codes as original data. On the other hand, no character codes are assigned to character images 225-1 to 225-5.

FIG. 2D shows buried character style information 235 which is an example of the buried character style information 230. Each piece of buried character style information 235 consists of a character image 236 itself and a character image ID 237 for identifying it uniquely.

The character image 236 is what is called a raster image (e.g., binary image) and includes pixels that form a character shape.

Unlike a character code to be used for information exchange, the character image ID 237 may be a code that allows the character image 236 to be recognized uniquely in the document 100.

A character image 236A is buried as character images 225-1 and 225-3 of the presentation character codes 225 in the example of FIG. 2C, a character image 236B is buried as a character image 225-2, a character image 236C is buried as a character image 225-4, and a character image 236D is buried as a character image 225-5. Like the character image 236A, the same character image may be buried at plural positions.

On the other hand, a character having a certain character code may correspond to different character images. For example, in one document 100, the same character maybe written in plural character styles. Therefore, there may occur an event that a recognition result of one character image 236 becomes the same as a recognition result of another character image 236 (naturally, having a different character image ID 237).

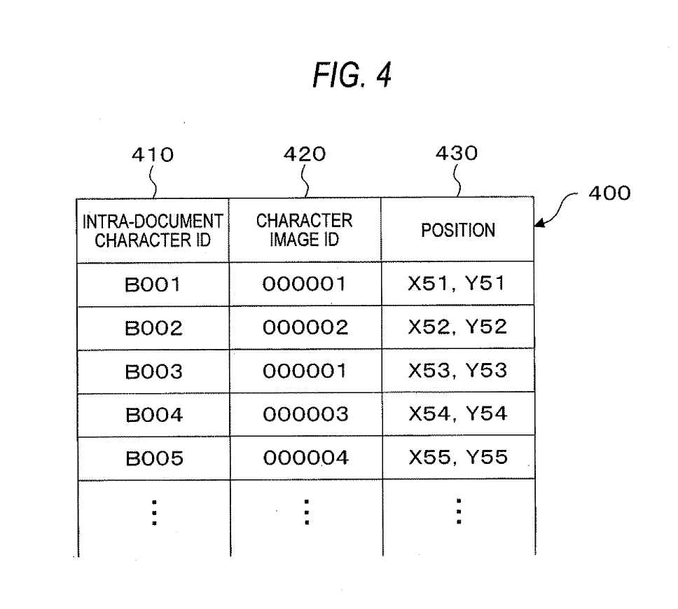

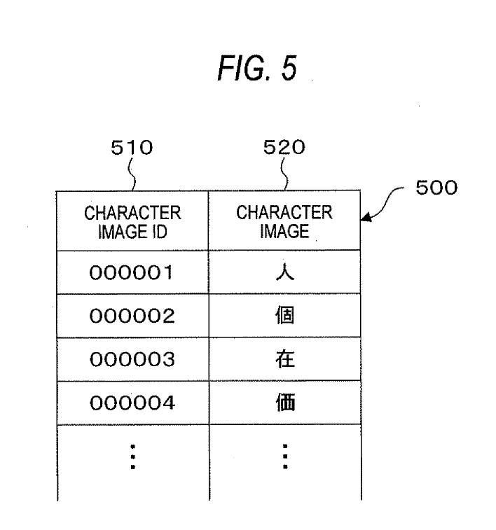

An example data structure of the buried character style information 230 is a buried character style information table 400 (illustrated FIG. 4) and a character image table 500 (illustrated in FIG. 5). As shown in FIG. 4, the buried character style information table 400 has an intra-document character ID column 410, a character image ID column 420, and a position column 430.

The intra-document character ID column 410 contains intra-document character IDs. The character image ID column 420 contains character image IDs for identifying the respective character images uniquely. Where the same character image is buried at plural positions, the same character image ID appears plural times. For example, in the example of FIG. 4, a character image ID “000001” is used for intra-document character IDs “B001” and “B003.”

The position column 430 contains positions of the characters in the document, and is equivalent to the position column 340 of the code information table 300 of FIG. 3. In the example of FIG. 4, they are sets of X and Y coordinates having the top-left corner of the document as the origin.

FIG. 5 illustrates the character image table 500 (example data structure), which has a character image ID column 510 and a character image column 520. The character image ID column 510 contains the character image IDs. The character image column 520 contains character images themselves.

For example, the presentation document 200 of FIG. 2A is presented by using the character code information table 300, the buried character style information table 400, and the character image table 500. More specifically, a computer that is to present the presentation document 200 generates character images of the character codes on the character code column 320 of the character code information table 300 using a font file provided in the computer and places them in the document using the information on the position column 340. And the computer extracts the character images shown on the character image ID column 420 of the buried character style information table 400 from the character image table 500 and places them in the document using the information on the position column 430.

The character information extracting module 120, which is connected to the document accepting module 110 and the recognition processing module 140, extracts pieces of character information from the document 100 received from the document accepting module 110.

The character image extracting module 130, which is connected to the document accepting module 110 and the recognition processing module 140, extracts character images from the document 100 received from the document accepting module 110.

The recognition processing module 140, which is connected to the character information extracting module 120, the character image extracting module 130, and the document shaping module 150, recognizes the character images extracted by the character image extracting module 130 using the pieces of character information extracted by the character information extracting module 120 and passes the pieces of character information and recognition results to the document shaping module 150.

The recognition processing module 140 is equipped with a control module 141, a language processing module 142, a recognition order control module 143, a character image generating module 144, and a character recognition module 145.

The control module 141 controls the other modules 142-145 in the recognition processing module 140. For example, the control module 141 controls the character recognition module 145 so that it recognizes a character image extracted by the character image extracting module 130 using pieces of character information located in the vicinity of the character image. The term “located” of “located in the vicinity of” means such a state in a case that a document is displayed on a display device or the like or a printed on a sheet of paper or the like. More specifically, in a succession of character images and pieces of character information, this term refers to pieces of character information located before or after a subject character image. Physically, in a horizontally-written document, this term refers to pieces of character information located on the left or right of a subject character image or pieces of character information located at the right end on a line immediately above or at the left end on a line immediately below in the case where a subject character image is located at the head or tail of a line. In a vertically-written document, this term refers to pieces of character information located over or under of a subject character image or pieces of character information located at the bottom on a line immediately on the right or at the head on a line immediately on the left in the case where a subject character image is located at the head or tail of a line. Each piece of character information that the control module 141 passes to the character recognition module 145 may contain, in addition to a character code, information of a character size, a character style, etc.

The control module 141 may perform a control so that the character recognition module 145 recognizes character images in units of a character string extracted by the language processing module 142.

The control module 141 may perform a control so that the character recognition module 145 recognizes character images extracted by the character image extracting module 130 together with character images generated by the character image generating module 144. The control module 141 may correct a character recognition result of the character recognition module 145 using a recognition result of a character string including the same character image.

Furthermore, the control module 141 may perform a control so that the character recognition module 145 recognizes character images in order that is specified by the recognition order control module 143 in such a manner that each character string is recognized using recognition results obtained so far.

The language processing module 142 performs a morphological analysis on the pieces of character information extracted by the character information extracting module 120 and extracts character strings that include the character images extracted by the character image extracting module 130.

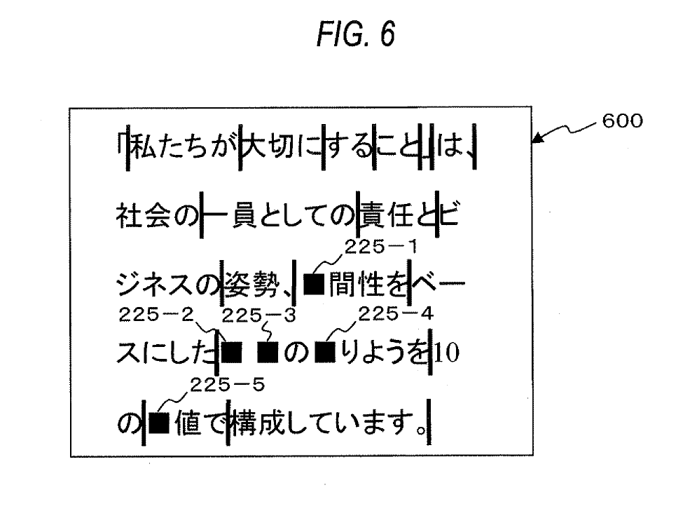

FIG. 6 illustrates an example morphological analysis result of the language processing module 142, that is, a result of a morphological analysis performed on the presentation character codes 225 of FIG. 2C.

The language processing module 142 decomposes a portion on which a morphological analysis can be performed into words and phrases, and extracts remaining portions (i.e. portions on which the morphological analysis cannot be performed) as words and phrases. For example, FIG. 6 shows that the Japanese sentence is decomposed in units of words or phrases. The mark “/” indicates a separator for a word or a phrase. A character string between two mark “/” indicates a word or a phrase. The mark “▪” indicates a character image. Among the divisional character strings, each character string having no character image is a word or a phrase which is a result of the morphological analysis. And, in many cases, each character string having a character image(s) is also a word or a phrase.

The language processing module 142 may perform a morphological analysis regarding each character image as an unknown character or a predetermined character (e.g., a kanji character(s)). Furthermore, the language processing module 142 may extract only words by decomposing the document 100 into words including even post positional particles, auxiliary verbs, etc.

The language processing module 142 extracts character strings having a character image(s) from the results of the morphological analysis. In the example of FIG. 6, the character string having a character image 225-1, the character string having character images 225-2, 225-3 and 225-4 and the character string having a character image 225-5 are shown.

Using the above results, the control section 141 controls the character recognition module 145 so that it recognizes the character images in units of a character string having a character image.

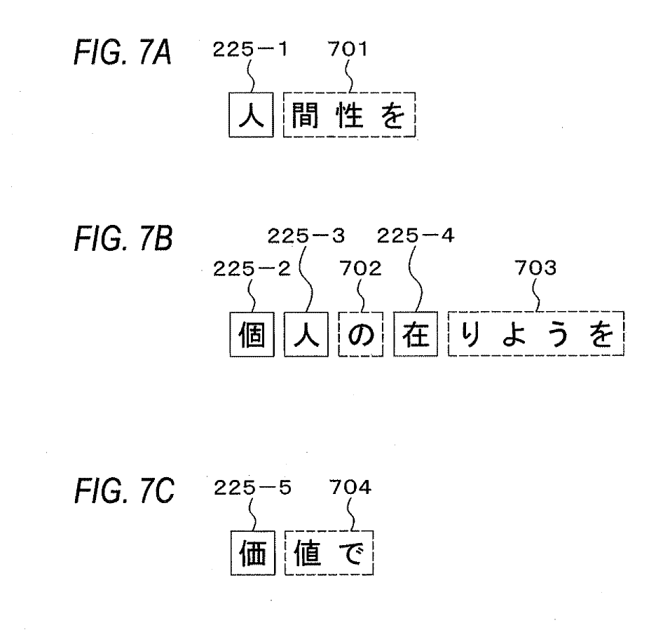

FIGS. 7A-7C illustrate example character images with connection character codes. In the example of FIG. 7A, the character string has a character image 225-1 and connection character codes 701. In the example of FIG. 7B, the character string has character images 225-2 and 225-3 a connection character code 702, a character image 225-4 and connection character codes 703. In the example of FIG. 7C, the character string has a character image 225-5 and connection character codes 704. For example, to cause the character recognition module 145 to recognize the character image 225-1, the control module 141 passes to it, in addition to the character image 225-1, the connection character codes 701 which are connected to the character image 225-1 from behind. After character-recognizes the character image 225-1, the character recognition module 145 connects the connection character codes 701 to a recognition result and performs a final recognition by matching a resulting character string with a word dictionary provided in the character recognition module 145.

The recognition order control module 143 controls the order of character images to be recognized by the character recognition module 145, and passes information indicating resulting order to the control module 141. For example, the recognition order control module 143 generates such order that the character recognition module 145 will recognize character strings in ascending order of the number of character images included. In the case of character strings having the same character image, the character recognition module 145 may recognize those character strings in ascending order of the number of character images included.

The character image generating module 144 generates character images based on pieces of character information that are part of each character string having a character image(s) among the character strings extracted by the language processing module 142.

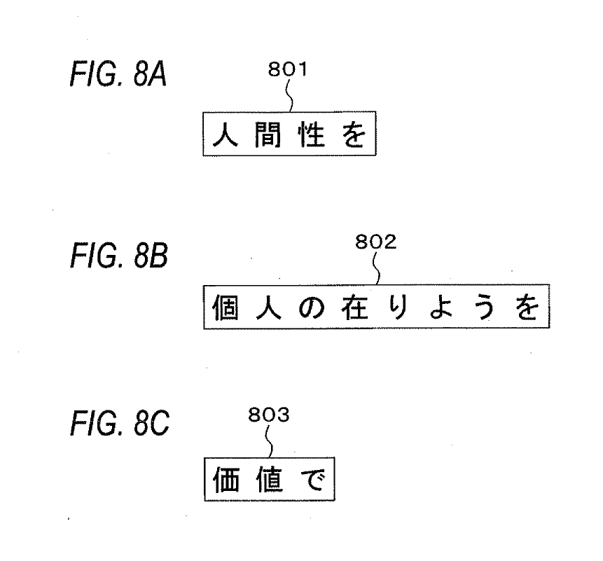

FIGS. 8A-8C illustrate example character image strings each of which is generated after the connection character codes are converted into character images. In the example of FIG. 8A, a character image string 801 is generated by generating character images of the character codes of the character string that was extracted by the language processing module 142. In the example of FIG. 8B, a character image string 802 is generated by generating character images of the character codes of the character string. In the example of FIG. 8C, a character image string 803 is generated by generating character images of the character codes of the character string.

More specifically, in the example of FIG. 8A, the three character codes are extracted from the character code column 320 and character images corresponding to these character codes are generated. Character images having such character styles as to be recognized by the character recognition module 145 at high recognition ratios may be generated. Then, a character image is extracted from the character image column 520 of the character image table 500. The character string image 801 is generated by connecting the thus-generated character images in order. Similar processing is performed in the examples of FIGS. 8B and 8C.

For example, to cause the character recognition module 145 to recognize the character image the control module 141 causes the character image generating module 144 to generate the character image string 801 and passes it to the character recognition module 145. This method is used in the case where the character recognition module 145 accepts only character images and character-recognizes them. The character recognition module 145 character-recognizes the character image string 801. In doing so, the character recognition module 145 performs final recognition by matching a recognition result character string with the word dictionary provided in the character recognition module 145. The word dictionary is stored with words and phrases that will occur in Japanese. The character recognition module stores the word dictionary.

The character recognition module 145 recognizes a character image(s). The character recognition module 145 also receives pieces of character information located before or after the recognition subject character image(s) and narrows down and corrects the recognition result by matching a character string consisting of those pieces of character information (in particular, character codes) and the recognition result. This character string is highly probably a word and matching with the word dictionary will succeed highly probably. The character recognition module 145 may recognize the character image(s) using information of character sizes and fonts included in pieces of character information received from the control module 141. For example, the character recognition module 145 may cutting out individual character images using the character sizes. Or the character recognition module 145 may perform character recognition using the fonts.

The character recognition module 145 receives a character image string including pieces of character information located before or after a recognition subject character image(s) (including a character image(s) generated by the character image generating module 144) and performs recognition by matching a recognition result of the character image string with the word dictionary. This character image string is highly probably a character string and matching with the word dictionary will succeed highly probably.

The document shaping module 150, which is connected to the recognition processing module 140 and the document output module 160, shapes the document 100 based on the pieces of character information extracted by the character information extracting module 120 and recognition results of the character recognition module 145. The term “shaping” means replacing the character images in the original document 100 with pieces of character information which are recognition results of the former. Furthermore, for example, the original pieces of character information (e.g., positions) maybe converted by replacing the character images with pieces of character information. The document shaping module 150 may generates a document mainly having text information on the basis of the character information and the recognition results.

The document output module 160, which is connected to the document shaping module 150, receives the document 100 as shaped by the document shaping module 150 and outputs the shaped document 100. The term “to output the shaped document 100” includes printing it with a printing apparatus such as a printer, displaying it on a display device, transmitting its image with an image transmitting apparatus such as a facsimile machine, writing it to a storage device such as a document database, storing it in a storage medium such as a memory card, and passing it to another information processing apparatus.

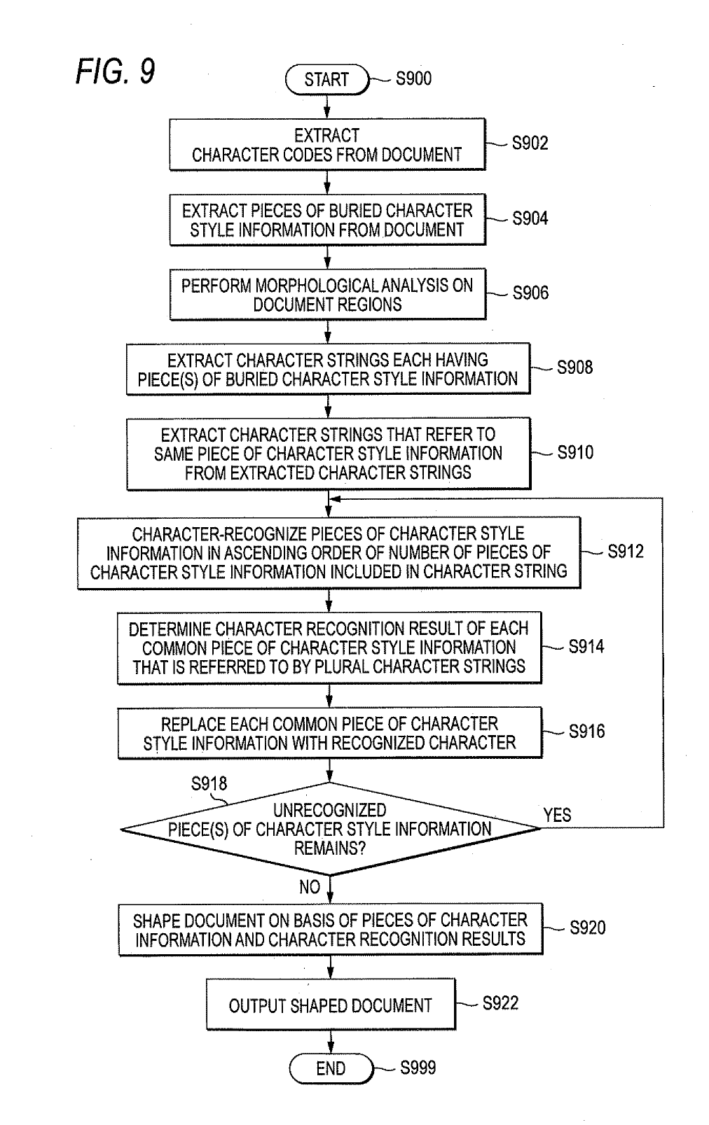

FIG. 9 is a flowchart of an example process according to the first exemplary embodiment. At step S902, the character information extracting module 120 extracts, from a document, character codes which are parts of pieces of character information. At step S904, the character image extracting module 130 extracts, from the document, pieces of buried character style information which are character images. At step S905, the language processing module 142 performs a morphological analysis on document regions where the character codes exist.

At step S908, the language processing module 142 extracts character strings each having a piece(s) of buried character style information. At step S910, the recognition order control module 143 extracts character strings that refer to the same piece of character style information from the character strings extracted at step S908. The recognition order control module 143 determines recognition order of the character strings extracted by itself.

At step S912, the character recognition module 145 character-recognizes the pieces of buried character style information in ascending order of the number of pieces of buried character style information included in the character string under the control of the control module 141. In the above-described example, the character recognition module 145 recognizes the character string having the character image 225-1 first. Although the subject of recognition of the character recognition module 145 is the character image 225-1, the information that is passed to the character recognition module 145 under the control of the control section 141 may be either the character image 225-1 plus the pieces of character information or the character image string including the character image 225-1.

At step S914, the control module 141 determines a character recognition result of each common piece of character style information that is referred to by plural character strings. For example, if the two character recognition results are the same, the same character recognition result is employed. If the two character recognition results do not coincide with each other, a character recognition result of a character string having a smaller number of character images may be employed. Alternatively, a character recognition result to be employed may be determined by the majority rule or according to the reliability of each character recognition result. All of part of these methods may be combined. For example, if two sets of character strings cause different character recognition results and have the same number of character strings, reliability-based decision may be made because the majority rule is not usable. Reliability is calculated on the basis of the distances between features of a character image and features in a recognition dictionary, the degree of matching between a recognition result and the word dictionary, or the like.

At step S916, the control module 141 replaces the common pieces of character style information with recognized characters. At step S918, the control module 141 judges whether an unrecognized piece(s) of character style information remains or not. If an unrecognized piece(s) of character style information remains, the process returns to step S912. If not, the process moves to step S920.

At step S920, the document shaping module 150 shapes the document based on the pieces of character information and character recognition results. That is, the document shaping module 150 replaces the pieces of buried character style information with the character recognition results (i.e., adds pieces of character information). At step S922, the document output module 160 outputs the shaped document.

### Second Exemplary Embodiment

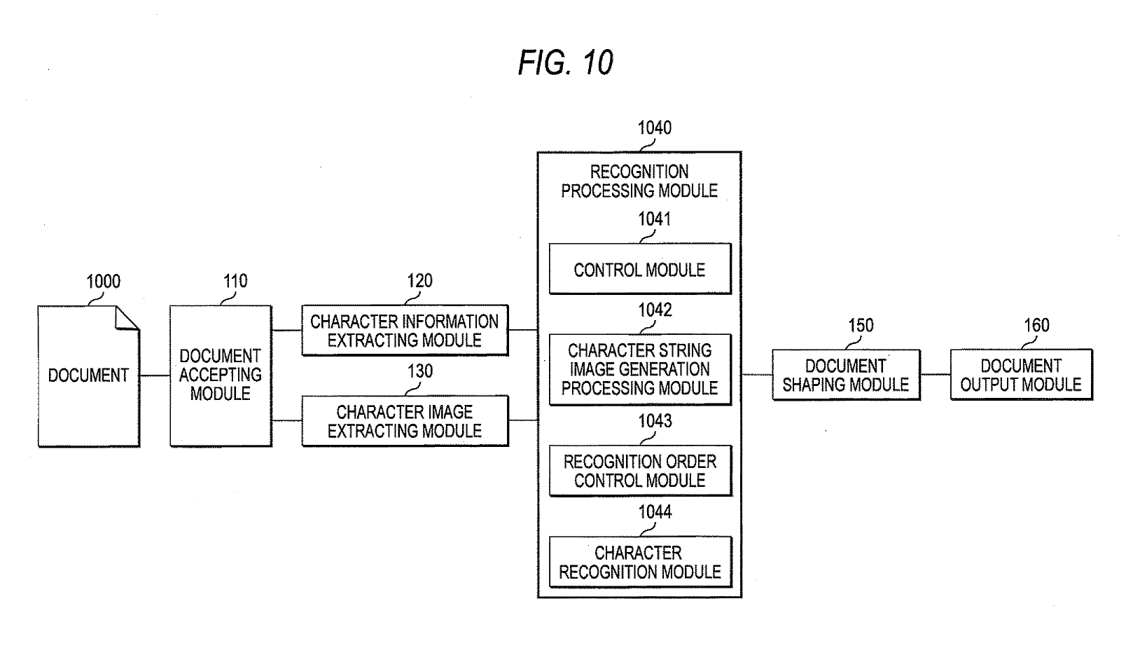

As shown in FIG. 10, an image processing apparatus according to a second embodiment, which serves to recognize character images of a document which may have pieces of character information and character images in mixture, is equipped with a document accepting module 110, a character information extracting module 120, a character image extracting module 130, a recognition processing module 1040, a document shaping module 150, and a document output module 160.

Things having the same ones in the first embodiment will be given the same reference symbols as the latter and will not be described redundantly.

The document accepting module 110, which is connected to the character information extracting module 120 and the character image extracting module 130, accepts a document 1000 which may have pieces of character information and character images in mixture and passes the accepted document 1000 to the character information extracting module 120 and the character image extracting module 130.

The term “document 1000 which may have pieces of character information and character images in mixture” is equivalent to the term “document 100” used in the above-described first embodiment, and means a document at least having a mechanism which allows presence of pieces of character information and character images in mixture. This term includes a document that consists of only character images (i.e., does not include any piece of character information). A document that consists of only pieces of character information (i.e., does not include any character image) need not be subjected to character recognition and hence is not a subject of this embodiment.

Although the language of characters written in a document 1000 maybe any language, the second embodiment is particularly suitable for languages (e.g., English, French, and German) of a code system in which each character can be represented by one byte. In these languages, the probability that pieces of character information and character images exist in mixture is low because the numbers of kinds of characters are smaller than in two-byte-code languages. For example, where character images are buried in an English PDF document, character images of all characters used are buried in the PDF document because the number of kinds of characters is smaller in English than in Japanese and hence only a small capacity is required. This method is mainly employed in, for example, a case that it is desired to use an original font. On the other hand, where a general font is employed, a PDF document having pieces of character information and character images in mixture is not generated because alphabetical characters can be drawn in almost all environments. That is, a PDF document includes only pieces of character information (i.e., does not include character images). This type of document is not a subject of this embodiment. The following description will be mainly directed to a case of English. A document 1000 may be a business document, a brochure for advertisement, or the like.

As in the above-described first embodiment, a piece of character information may contain, in addition to a character code, such information as a character size, a position (coordinates) in a document where the character is to be displayed, and a font. The term “character image” means an image of a displayed character (rasterized image) and may be either an image of a single character or plural characters. A character image may contain, in addition to an image, such information as a position (coordinates) in a document the character is to be displayed. However, no character code corresponds to each character image of a document 1000 to be accepted by the document accepting module 110.

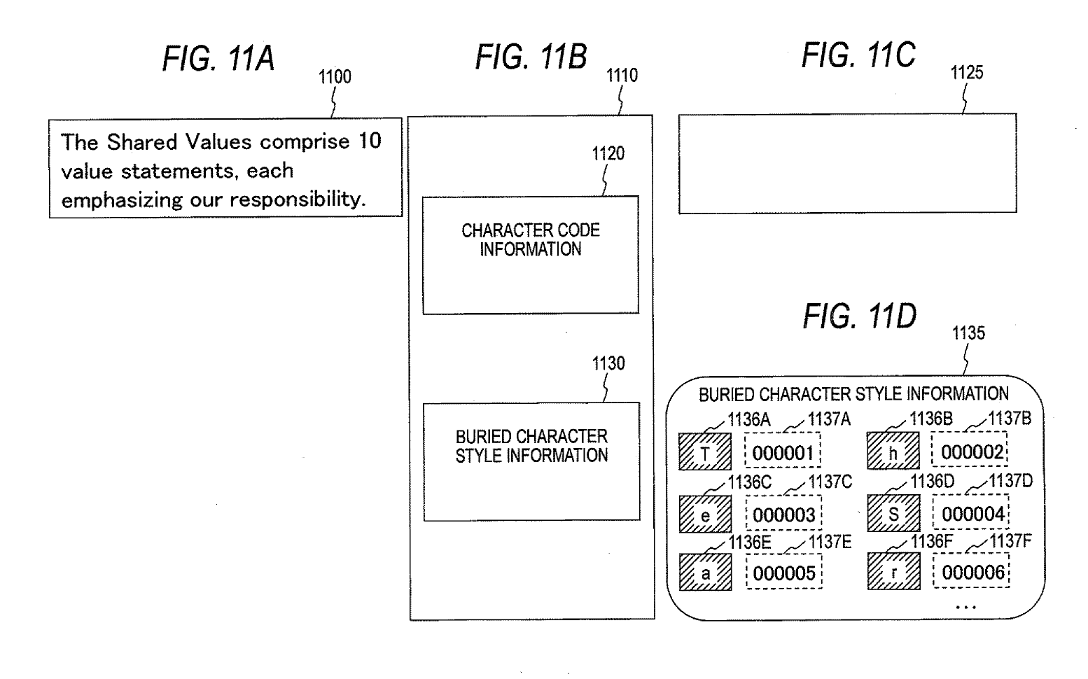

FIGS. 11A-11D illustrate various example forms of a document 1000. FIG. 11A shows an example presentation document 1100 which is the document 1000 that is displayed on a display device or the like or printed on a medium such as a sheet of paper. Although only characters appear in the presentation document 1100, its original data contains only character images or character images and character codes (pieces of character information).

FIG. 11B shows example main data of the document 1000. Intra-document data 1110 consists of character code information 1120 (pieces of character information) and buried character style information 1130 (character images). An example data structure of the character code information 1120 is a character code information table 300 which is similar to the one illustrated in FIG. 3. The character code column 320 contains character codes representing English characters. There may occur a case that the intra-document data 1110 does not include character code information 1120.

FIG. 11C shows presentation character codes 1125 that are the character code information 1120 that is displayed on a display device or printed on a medium such as a sheet of paper. This example corresponds to a case that the intra-document data 1110 does not include character code information 1120. That is, no character information is displayed.

FIG. 11D shows buried character style information 1135 which is an example of the buried character style information 1130. Each piece of buried character style information 1135 consists of a character image 1136 itself and a character image ID 1137 for identifying it uniquely.

The character image 1136 is what is called a raster image (e.g., binary image) and includes pixels that form a character shape.

Unlike a character code to be used for information exchange, the character image ID 1137 may be a code that allows the character image 1136 to be recognized uniquely in the document 1000.

As shown in the example of FIG. 11D, the character “T” used in the document 1000 is represented by a character image 1136A and a character image ID 1137A indicating it.

Like the character “h” in the presentation document 1100, the same character image may be buried at plural positions.

On the other hand, a character having a certain character code may correspond to different character images. For example, in one document 1000, the same character may be written in plural character styles. Therefore, there may occur an event that a recognition result of one character image 1136 becomes the same as a recognition result of another character image 1136 (naturally, having a different character image ID 1137).

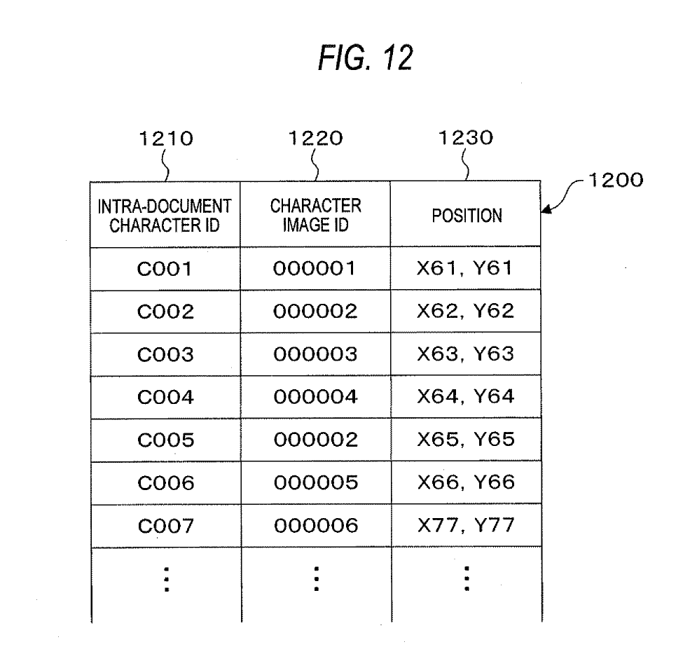

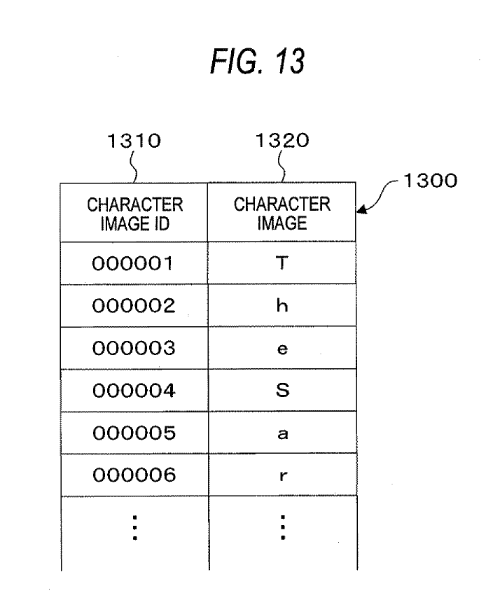

An example data structure of the buried character style information 1130 is a buried character style information table 1200 (illustrated in FIG. 12) and a character image table 1300 (illustrated in FIG. 13). As shown in FIG. 12, the buried character style information table 1200 has an intra-document character ID column 1210, a character image ID column 1220, and a position column 1230.

The intra-document character ID column 1210 contains intra-document character IDs. The character image ID column 1220 contains character image IDs for identifying the respective character images uniquely. Where the same character image is buried at plural positions, the same character image ID appears plural times. For example, in the example of FIG. 12, a character image ID “000002” is used for intra-document character IDs “C002” and “C005.”

The position column 1230 contains positions of the characters in the document, and is equivalent to the position column 340 of the character code information table 300 of FIG. 3. In the example of FIG. 12, they are sets of X and Y coordinates having the top-left corner of the document as the origin.

FIG. 13 illustrates the character image table 1300 (example data structure), which has a character image ID column 13510 and a character image column 1320. The character image ID column 1310 contains the character image IDs. The character image column 1320 contains character images themselves.

For example, the presentation document 1100 of FIG. 11A is presented by using the character code information table 300, the buried character style information table 1200, and the character image table 1300. More specifically, a computer that is to present the presentation document 1100 generates character images of the character codes in the character code column 320 of the character code information table 300 using a font file provided in the computer and places them in the document using the information in the position column 340 (in the case of the presentation document 1100, this processing need not be performed because there is no character code information 1120). And the computer extracts the character images indicated by the character image ID column 1220 of the buried character style information table 1200 from the character image table 1300 and places them in the document using the information in the position column 1230.

The recognition processing module 1040, which is connected to the character information extracting module 120, the character image extracting module 130, and the document shaping module 150, recognizes character images extracted by the character image extracting module 130 and passes pieces of character information and recognition results to the document shaping module 150. In particular, in the case where the document 1000 does not contain any character information, the recognition processing module 1040 recognizes character images extracted by the character image extracting module 130 using character recognition results that have been obtained so far by the recognition processing module 1040 itself and passes recognition results to the document shaping module 150.

The recognition processing module 1040 is equipped with a control module 1041, a character string image generation processing module 1042, a recognition order control module 1043, and a character recognition module 1044.

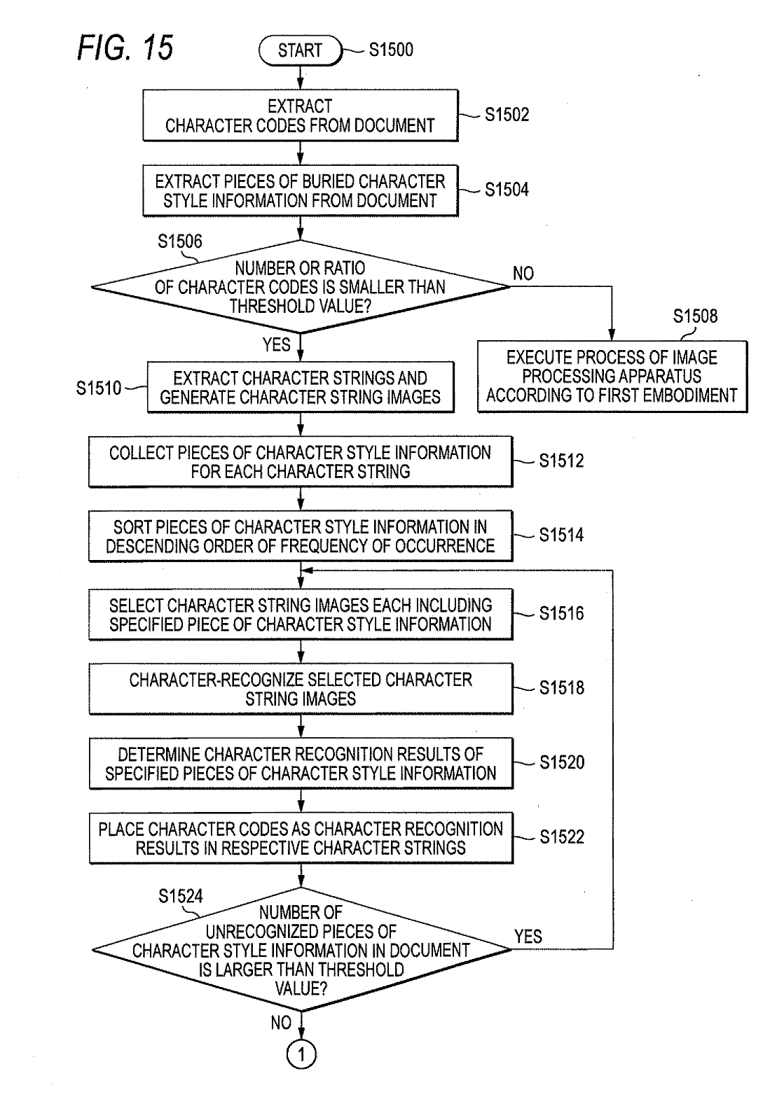

The control module 1041 judges whether to cause the character string image generation processing module 1042 to operate on the basis of the number of pieces of character information extracted by the character information extracting module 120 or a ratio between the number of pieces of character information extracted by the character information extracting module 120 and the number of character images extracted by the character image extracting module 130. For example, this processing corresponds to step S1506 shown in FIG. 15 (described later).

The control module 1041 may correct a character recognition result of the character recognition module 1044 on the basis of recognition results of character string images including the same character image. For example, this processing corresponds to step S1520 shown in FIG. 15 (described later).

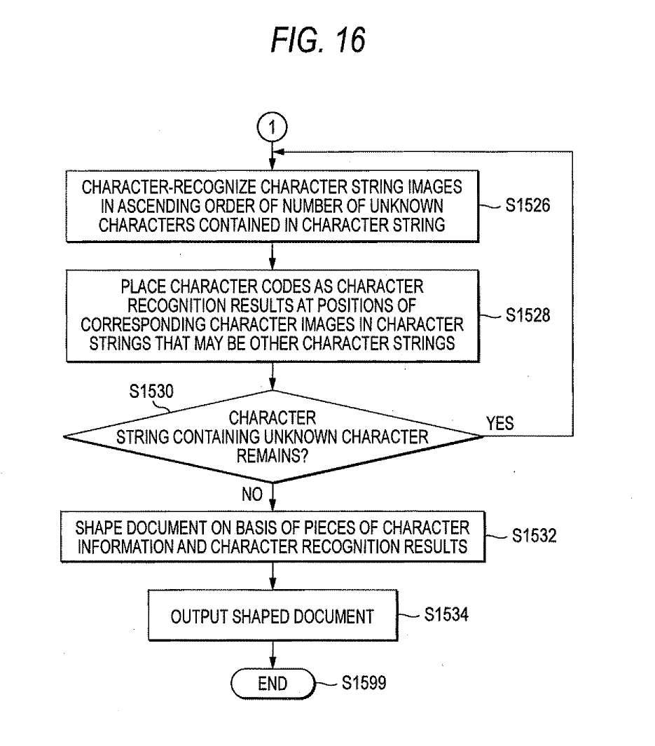

The control module 1041 may cause the character recognition module 1044 to use a character recognition result of a character image obtained by the character recognition module 1044 by recognizing a character string image, to recognize another character string image containing this character image. For example, this processing corresponds to steps S1526 and S1528 shown in FIG. 16 (described later).

The control module 1041 may control the character recognition module 1044 so that the character recognition module 1044 recognizes the character string images in ascending order of the number of unknown characters and recognizes other character string images on the basis of recognition results of character string images that have already been recognized. For example, this processing corresponds to steps S1526 and S1528 shown in FIG. 16 (described later).

The term “unknown character” means a character image that has not been recognized by the character recognition module 1044 yet or a character image that has already been recognized by the character recognition module 1044 but its recognition result has not been determined yet. More specifically, it is a character image that has not been determined by step S1520 shown in FIG. 15 (described later) yet and has not been subjected to character recognition of step S1526 shown in FIG. 16 (described later) yet.

The character string image generation processing module 1042 generates a character string image that is enclosed by spaces on the basis of positions in the document 1000 of the character images extracted by the character image extracting module 130 or pieces of space information relating to spaces in the document 1000.

The term “(a piece of) space information relating to a space in the document” is character information of a space character in the case where pieces of character information which are mixed with character images include space characters, position information of a space character image (including position information of a space character image in the document or information indicating a positional relationship with another character image if there is no space character image) in the case where spaces are represented by character images, information indicating that a space exists before or after a character image in the case where such information is available, or like information. A character image may be judged to be a space character image if it does not include a black pixel or if its character image ID is a predetermined code in the case where the character image ID that is assigned to the space character image is the predetermined code. Judging whether or not a space exists using “information indicating a positional relationship with another character image if there is no space character image” means judging whether or not a space exists using positions of character images that are not a space. If character images are spaced from each other by a distance that is longer than a distance between character images in a word (e.g., a most frequently occurring distance between character images), it may be judged to be a space.

The term “enclosed by spaces” means that a space exists before and after a group of character images in a succession of sentences. Physically, in a horizontally-written document, this term means that pieces of space information are located on the left and right of a group of character images, that a piece of space information is located on the right of a group of character images in the case where the group of character images is located at the head of a line, or that a piece of space information is located on the left of a group of character images in the case where the group of character images is located at the tail of a line. In a vertically-written document, this term that pieces of space information are located over and under a group of character images, that a piece of space information is located under a group of character images in the case where the group of character images is located at the head of a line, or that a piece of space information is located over a group of character images in the case where the group of character images is located at the tail of a line.

The term “character string image enclosed by spaces” means a group of character images consisting of one or more character images. In a language in which words are written so as to be spaced from each other, such a character string mainly corresponds to a word. The following description will be directed to a case that such character strings are mainly words.

More specifically, the character string image generation processing module 1042 analyze the “pieces of space information relating to spaces in the document 1000,” extracts the character images of a group of character images that is sandwiched between each pair of spaces from the character image column 1320 of the character image table 1300, and connects the extracted character images together.

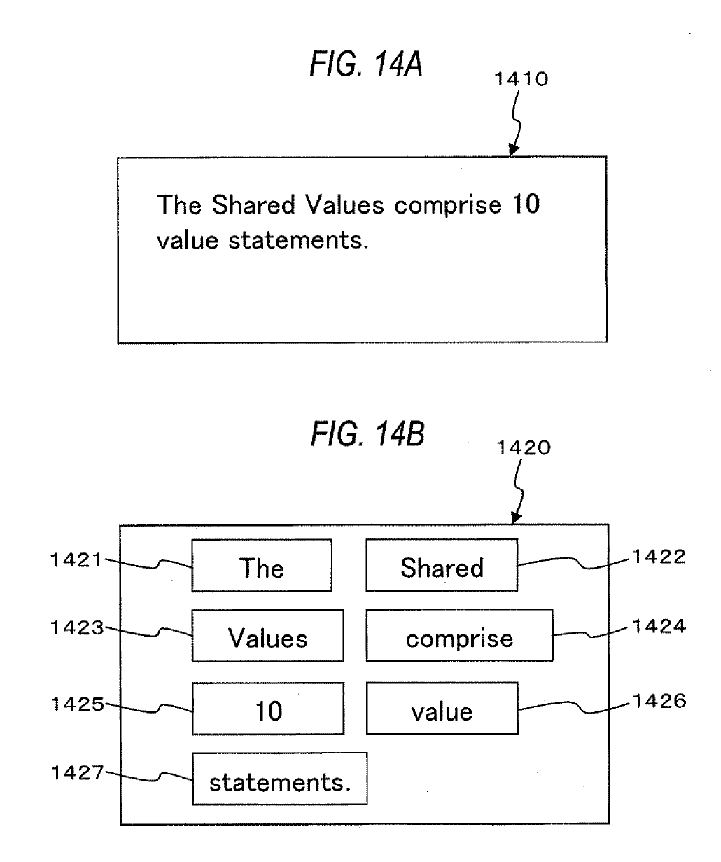

FIGS. 14A and 14B illustrate an example of presentation of a subject document and an example result 1420 of word separation performed by the character string image generation processing module 1042, respectively.

The character string image generation processing module 1042 outputs the word separation result 1420 shown in FIG. 14B when having processed a subject presentation document 1410 shown in FIG. 14A. The word separation result 1420 includes seven word images 1421-1427. For example, the character string image generation processing module 1042 calculates distances between character images using their positions (extracted from the position column 1230 of the buried character style information table 1200), employs a most frequently occurring value among calculation results as a distance in a word, and judges that a distance between character images that is longer than the employed distance corresponds to a space. The character string image generation processing module 1042 extracts character images enclosed by spaces (for the word images 1421 and 1426 each of which is located at the head of a line, character images having a space behind them should be extracted; for the word image 1425 which is located at the tail of a line, character images having a space before them should be extracted) from the character image column 1320 of the character image table 1300, and generates a character string image (group of character images) by connecting the extracted character images together.

The recognition order control module 1043 performs a control so that the character recognition module 1044 will recognize the character string images generated by the character string image generation processing module 1042 in order that is based on frequencies of occurrence of the character image IDs which serve for unique identification of the character images extracted by the character image extracting module 130. For example, this processing corresponds to steps S1512, S1514, and S1516 shown in FIG. 15.

The character recognition module 1044 recognizes the character images in each character string image. The character recognition module 1044 also receives pieces of character information located before or after the recognition subject character images and narrows down and corrects a recognition result by matching a character string consisting of those pieces of character information (in particular, character codes) and the recognition result. This character string is highly probably a word and matching with a word dictionary will succeed highly probably. The character recognition module 1044 may recognize the character images using character sizes and fonts included in pieces of character information received from the control module 1041. For example, the character recognition module 1044 may cut out individual character images from the character string image using the character sizes. Or the character recognition module 1044 may perform character recognition using the fonts.

The character recognition module 1044 receives a character image string including pieces of character information located before or after recognition subject character images (including a string character image generated by the character string image generation processing module 1042) and performs recognition by matching a recognition result of the character image string with the word dictionary. This character image string is highly probably a word and matching with the word dictionary will succeed highly probably.

The pieces of character information that are received by the character recognition module 1044 may include recognition results of recognition processing that was performed by the character recognition module 1044 itself.

The word dictionary is stored with words that can be English words, and is provided in the character recognition module 1044.

The document shaping module 150, which is connected to the recognition processing module 1040 and the document output module 160, shapes the document 1000 on the basis of the recognition results of the character recognition module 1044. The document shaping module 150 may shape the document 1000 on the basis of the pieces of character information extracted by the character information extracting module 120 and the recognition results of the character recognition module 1044. As mentioned above, the term “shaping” means replacing the character images in the original document 1000 with pieces of character information which are recognition results of the former. Furthermore, for example, the original pieces of character information (e.g., positions) may be converted by replacing the character images with pieces of character information. As another form of shaping, a document that is mainly formed by a text may be generated on the basis of recognition results (or pieces of character information and recognition results).

FIGS. 15 and 16 are flowcharts of an example process according to the second embodiment. At step S1502, the character information extracting module 120 extracts, from a document, character codes which are parts of pieces of character information. At step S1504, the character image extracting module 130 extracts, from the document, pieces of buried character style information which are character images.

At step S1506, the control module 1041 judges whether or not the number of character codes or the ratio of the number of character codes to the number of character images is smaller than a threshold value. The process moves to step S1510 if it is smaller than the threshold value, and moves to step S1508 if not. The threshold value is a predetermined value (this also applies to the following description). For example, the process may be such as to move to step S1510 if the document includes no character code. For example, as is understood from the above description, the process moves to step S1510 in the case of an English document and moves to step S1508 in the case of a Japanese document.

At step S1508, a process (e.g., step S906 and the following steps) of the image processing apparatus according to the first embodiment is executed. At step S1510, the character string image generation processing module 1042 extracts character strings each of which is enclosed by spaces and generates images of the extracted character strings.

At step S1512, the recognition order control module 1043 collects pieces of character style information for each character string. More specifically, the recognition order control module 1043 collects character image IDs of the characters constituting each character string.

At step S1514, the recognition order control module 1043 sorts pieces of character style information in descending order of the frequency of occurrence. More specifically, the recognition order control module 1043 calculates frequencies of occurrence of the respective pieces of character style information and sorts them in descending order of the frequency of occurrence.

At step S1516, the recognition order control module 1043 selects character string images each including one of pieces of specified character style information. The term “pieces of specified character style information” means a top, predetermined number of pieces of character style information among the pieces of character style information as sorted at step S1514 when step S1516 is executed first time (executed after step S1514), and means a predetermined number of pieces of character style information that are lower in rank than the pieces of character style information that were specified at the time of preceding execution of step S1516 when step S1516 is executed second time or later (executed after step 1524). Step S1516 allows character images having high frequencies of occurrence in the document to be made subjects of character recognition early. If a specified character image is included in plural character strings, plural character string images are selected. For example, in the example of FIG. 14B, “e” is a character image having a high frequency of occurrence. Word images 1421-1424, 1426, and 1427 are selected as character string images including the character image “e.”

At step S1518, the character recognition module 1044 character-recognizes the character string images selected at step S1516. The character recognition module 1044 performs matching with the word dictionary because it recognizes each character string image which is a word rather than each character image.

At step S1520, the control module 1041 determines character recognition results of the specified pieces of character style information. For example, in the example of FIG. 14B, assume that the word images 1421-1424, 1426, and 1427 which are character string images including the character image “e” have been character-recognized and that the character image “e” has been recognized correctly as a character code “e” in five of these word images and the character image “e” has been recognized erroneously as a character code “a” in one of these word images. Even in such a case, it is determined by the majority rule that the character recognition result of the character image “e” should be character code “e.” At step S1518, the character string images are recognized, that is, pieces of character style information other than the specified ones are also recognized. Recognition results of the latter pieces of character style information may be either deleted (i.e., will not be used in later steps) or stored so as to be correlated with the respective pieces of character style information so as to be used for character recognition at step S1526.

Step S1520 may be omitted if the character recognition module 1044 has a function of recognizing a character image utilizing a fact that same character image is included in plural character string images. This means that the character recognition module 1044 performs processing that is equivalent to step S1520. That is, one character recognition result is determined for each specified piece of character style information when step S1518 has been executed.

At step S1522, the character codes as the character recognition results are placed in the respective character strings. That is, the character codes that were determined at step S1520 are placed in the respective character strings as finalized character recognition results.

At step S1524, the control module 1041 judges whether or not the number of unrecognized pieces of character style information in the document is larger than a threshold value. The process returns to step S1516 if it is larger than the threshold value, and moves to step S1526 if not. The threshold value may be set according to the number of character images contained in the document. Whether the process should return to step S1516 or move to step S1526 may be judged on the basis of a ratio between the number of recognized pieces of character style information to the number of unrecognized pieces of character style information.

At step S1526, the control module 1041 causes the character recognition module 1044 to character-recognize character string images in ascending order of the number of unknown characters contained in the character string. That is, character string images are character-recognized in descending order of the number of finalized characters.

At step S1528, the control module 1041 places character codes as character recognition results of step S1526 at the positions of corresponding character images in character strings that may be other character strings.

At step S1530, the control module 1041 judges whether or not there remains a character string containing an unknown character. If such a character string remains, the process returns to step S5126. If not, the process moves to step S1532.

At step S1532, the document shaping module 150 shapes the document on the basis of the pieces of character information and the character recognition results. That is, the document shaping module 150 replaces the pieces of buried character style information with the recognition results (i.e., adds pieces of character information). At step S1534, the document output module 160 outputs the shaped document.

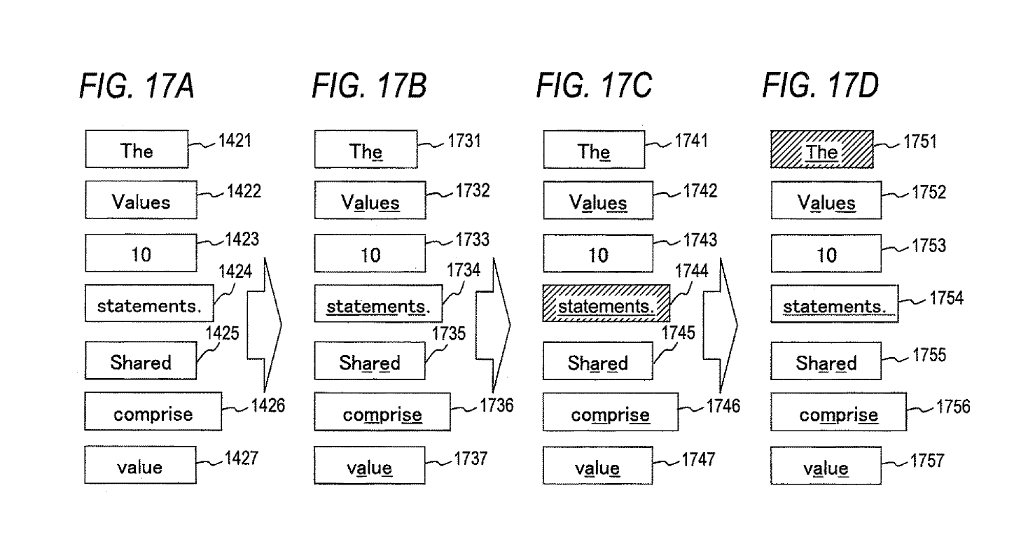

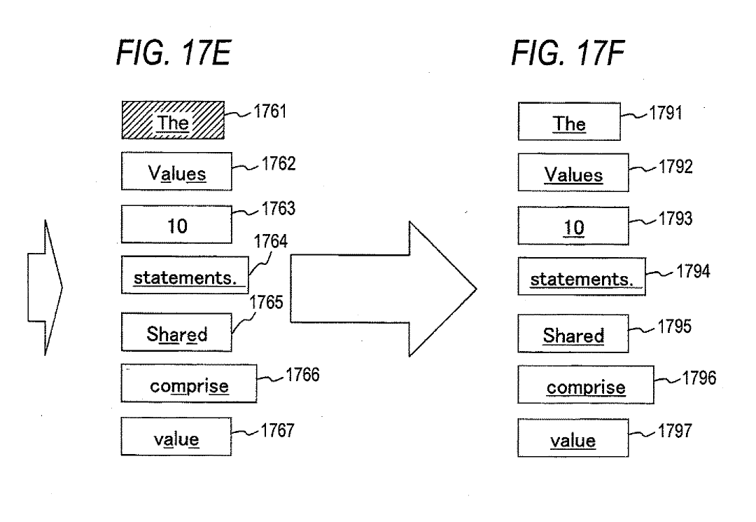

FIGS. 17A-17F illustrate a specific example operation performed in the second embodiment. FIG. 17A shows example character string images generated at step S1510, which are the same as shown in FIG. 14B (however, they are assigned reference numerals in a different manner).

FIG. 17B shows a result of execution of steps S1516, 1518, and 1520. At step S1516, pieces of character style information “a,” “e,” “s,” “t,” and “m” are specified. At step S1518, word images 1421, 1422, and 1424-1427 are character-recognized. At step S1520, character recognition results of “a,”0 “e,” “s,” “t,” and “m” are determined and character codes as the character recognition results are placed in the individual character strings. For example, in recognition in-progress data 1731, “Th” is character images and “e” is a character code. Underlines in FIG. 17B-17F indicate that character codes are finalized for the associated characters.

FIG. 17C shows a result of execution of step S1526. Recognition in-progress data 1734 is selected and the character recognition module 1044 character-recognizes it. The character recognition finalizes character codes for “n” and “.” of the recognition in-progress data 1734, whereby a recognition result 1744 is obtained.

FIG. 17D shows another result of execution of step S1526. Recognition in-progress data 1741 is selected and the character recognition module 1044 character-recognizes it. The character recognition finalizes character codes for “T” and “h” of the recognition in-progress data 1741, whereby a recognition result 1751 is obtained.

FIG. 17E shows a result of execution of step S1528. The character code of “h” that was finalized at step S1526 is placed at the position of the character image “h” in recognition in-progress data 1755, whereby recognition in-progress data 1765 is obtained.

FIG. 17F shows a final state that there is no character string image containing an unknown character(s), which state is obtained by executing steps S1526 and S1528 repeatedly.

Two-stage character recognition is performed in the process of FIGS. 15 and 16. The first-stage character recognition consists of steps S1516-S1524 in which character string images containing characters having high frequencies of occurrence. The second-stage character recognition consists of steps S1526-S1530 in which character string images are character-recognized in ascending order of the number of unfinalized characters contained using the character recognition results of the first-stage character recognition. Alternatively, only the first-stage character recognition may be performed (the second-stage character recognition is omitted).

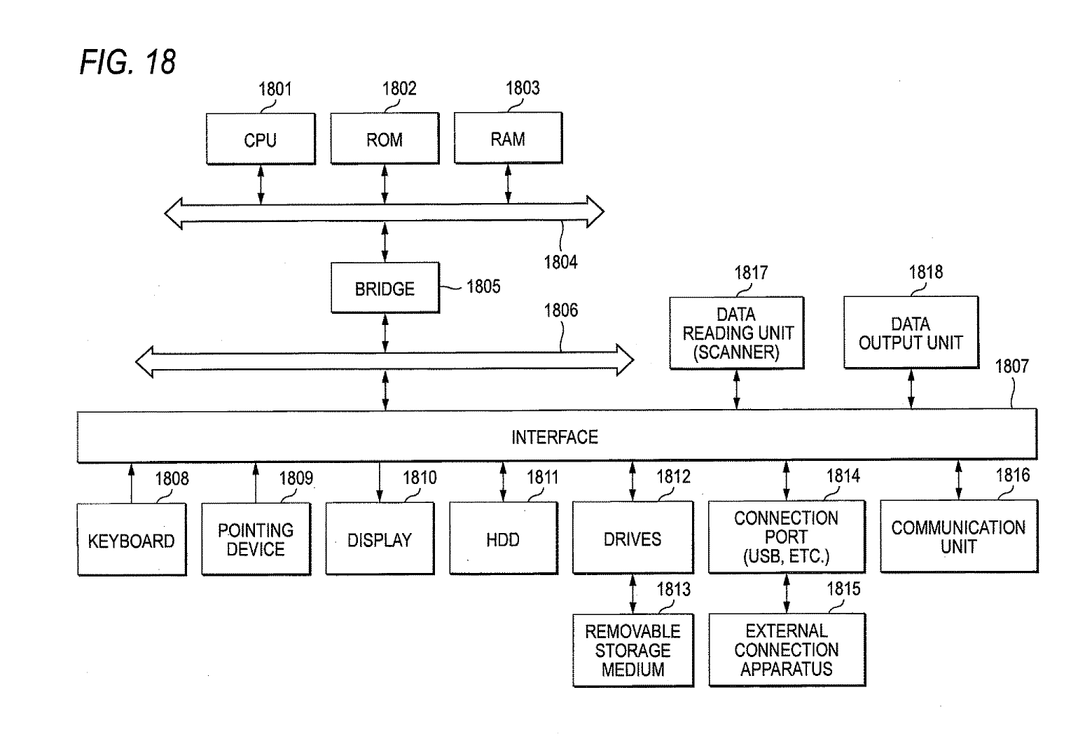

An example hardware configuration of the image processing apparatus according to the first and second exemplary embodiment will be described below with reference to FIG. 18. FIG. 18 shows an image processing apparatus such as a personal computer (PC) which is equipped with a data reading unit 1817 such as a scanner and a data output unit 1818 such as a printer.

A CPU 1801 is a control section which performs processing according to computer programs that described execution sequences of the above-described various modules such as the character information extracting module 120, the character image extracting module 130, the control module 141, the language processing module 142, and the recognition order control module 143.

A ROM 1802 stores the programs, calculation parameters, etc. to be used by the CPU 1801. A RAM 1803 stores a program that is executed by the CPU 1801, parameters that vary as the program is executed, and other information. The CPU 1801, the ROM 1802, and the RAM 1803 are connected to each other by a host bus 1804 which is a CPU bus or the like.

The host bus 1804 is connected to an external bus 1806 such as a PCT (peripheral component interconnect/interface) bus by a bridge 1805.

A keyboard 1808 and a pointing device 1809 such as a mouse are input devices which are manipulated by an operator. A display 1810, which is a liquid crystal display, a CRT (cathode-ray tube) display, or the like, displays various kinds of information in the form of a text or image information.

An HOD (hard disk drive) 1811, which incorporates hard disks, stores and reproduces programs and information to be executed by the CPU 1801 by driving the hard disks. An accepted document, pieces of character information, and character images are stored in the hard disks. The HDD 1811 also stores various computer programs including other various data processing programs.

Drives 1812 read data or a program from a removable storage medium 1813 such as a magnetic disk, an optical disc, a magneto-optical disc, or a semiconductor memory, and supplies the read-out data or program to the RAM 1803 which is connected to the derives 1812 via interfaces 1807, the external bus 1806, a bridge 1805, and the host bus 1804. Like the hard disks, the removable recording medium 1813 can also be used as a data storage area.

Connection ports 1814 are ports for connection of an external connection apparatus 1815 and have connection portions of USB, IEEE 1394, etc. The connection ports 1814 are connected to the CPU 1801 etc. via the interfaces 1807, the external bus 1806, the bridge 1805, the host bus 1804, etc. A communication unit 1816 is connected to a network and performs processing for a data communication with the outside. The data reading unit 1817 is a scanner, for example, and performs document reading processing. The data output unit 1818 is a printer, for example, and performs document data output processing.

The hardware configuration (of an image processing apparatus) of FIG. 18 is just an example and the invention is not limited to it. Any hardware configuration may be employed as long as it allows operation of the modules used in the exemplary embodiment. For example, part of the modules may be implemented as dedicated hardware (e.g., an application-specific integrated circuit (ASIC)). Part of the modules may be provided in an external system and connected via a communication line. Furthermore, plural systems each shown in FIG. 18 may be connected to each other by communication lines and cooperate with each other. Still further, the system of FIG. 18 may be incorporated in a copier, a facsimile machine, a scanner, a printer, a multifunction machine (i.e., an image processing apparatus having the functions of at least two of a scanner, a printer, a copier, a facsimile machine, etc.), or the like.

The above-described embodiments may be combined together (e.g., a module in one embodiment is applied to the other embodiment). Any of the techniques described in the “Background Art” section may be employed in any of the modules.

The terms “larger than or equal to,” “smaller than or equal to,” “larger than, ” and “smaller than” which are used in comparison with a predetermined value in the above embodiments may be replaced by “larger than,” “smaller than,” “larger than or equal to, ” and “smaller than or equal to, ” respectively, unless a discrepancy is caused in the relationship concerned.

A program which executes the above-described process may be either provided in such a manner as to be stored in a storage medium or provided via a communication means. In such a case, the aspect of the invention relating to the program may be recognized as a computer-readable storage medium stored with the program. The term “computer-readable storage medium stored with the program” means one that is used for program installation, execution, distribution, etc.

The storage medium includes DVDs (digital versatile discs) that comply with the standards DVD-R, DVD-RW, DVD-RAM etc. which were worked out by the DVD Forum or the standards DVD+R, DVD+RW, etc. which were worked out by the DVD+RW Alliance, CDs (compact discs) such as a CD-ROM (read-only memory), a CD-R (recordable), and a CD-RW (rewritable), a Blu-ray disc (registered trademark), an MO (magneto-optical disc), a FD (flexible disk), a magnetic tape, an HOD (hard disk drive), a ROM (read-only memory), an EEPROM (electrically erasable programmable read-only memory), a flash memory, and a RAM (random access memory).

The program or part of it may be, for example, put in storage or distributed being stored in any of the above storage media. The program or part of it may be transmitted over a transmission medium such as a wired network, a wireless network, or their combination used for a LAN (local area network), a MAN (metropolitan area network), a WAN (wide area network), the Internet, an intranet, an extranet, or the like, or transmitted being carried by a carrier wave.

The program may be part of another program and may be stored in a storage medium together with a separate program. The program may be stored in a divisional manner in different storage media. Furthermore, the program may be stored in any form as long as it can be restored, for example, in a compressed form or a coded form.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a document accepting section that accepts a document having pieces of character information and character images in mixture;
a character information extracting section that extracts the pieces of character information from the document accepted by the document accepting section;
a character image extracting section that extracts the character images from the document accepted by the document accepting section;
a character recognition section that recognizes the character images;
a character recognition control section that performs a control so as to cause the character recognition section to recognize a character image extracted by the character image extracting section by using pieces of character information that are located in the vicinity of said character image; and
a document shaping section that shapes the document on the basis of the pieces of character information extracted by the character information extracting section and character recognition results of the character recognition section.

2. The image processing apparatus according to claim 1, further comprising:
a character string extracting section that extracts character strings including the character images by performing a morphological analysis on the pieces of character information extracted by the character information extracting section,
wherein the character recognition control section performs the control so as to cause the character recognition section to recognize character images included in each character string extracted by the character string extracting section.

3. The image processing apparatus according to claim 2, further comprising:
a character image generating section that generates a character image string on the basis of pieces of character information in each extracted character string having the character images,
wherein the character recognition control section performs the control so as to cause the character recognition section to recognize the character images extracted by the character image extracting section together with the character image strings generated by the character image generating section.

4. The image processing apparatus according to claim 2,
wherein the character recognition control section corrects a character recognition result corresponding to a first one of the character strings using a recognition result of a second one of the character strings, and
the first one and the second one of the character strings have the same character image.

5. The image processing apparatus according to claim 2,
wherein the character recognition control section performs the control so as to cause the character recognition section to recognize the character strings in ascending order of the number of character images included in such a manner as to recognize each character string using recognition results obtained so far.

6. A computer readable medium storing a program causing a computer to execute a process for character recognition, the process comprising:
accepting a document having pieces of character information and character images in mixture;
extracting the accepted pieces of character information from the document;
extracting the accepted character images from the document;
recognizing the character images;
performing a control so as to recognize a extracted character image by using pieces of character information that are located in the vicinity of said extracted character image; and
shaping the document on the basis of the extracted pieces of character information and character recognition results by the recognition.

7. An image processing apparatus comprising:
a document accepting section that accepts a document having pieces of character information and character images in mixture;
a character image extracting section that extracts the character images from the document accepted by the document accepting section;
a character string image generating section that generates character string images each enclosed by spaces on the basis of positions, in the document, of the character images extracted by the character image extracting section or pieces of space information relating to spaces in the document;
a character recognition section that recognizes character images;
a character recognition control section that performs a control so as to cause the character recognition section to recognize character string images generated by the character string image generating section in order that is determined on the basis of occurrence frequencies of character image identification codes for unique identification of the character images extracted by the character image extracting section; and
a document shaping section that shapes the document on the basis of recognition results of the character recognition section.

8. The image processing apparatus according to claim 7, further comprising:
a character information extracting section that extracts the pieces of character information from the document accepted by the document accepting section; and
a judging section that judges whether to cause the character string image generating section to generate character string images on the basis of the number of the pieces of character information extracted by the character information extracting section, or a ratio between the number of the pieces of character information and the number of the character images extracted by the character image extracting section,
wherein the document shaping section shapes the document on the basis of the pieces of character information extracted by the character information extracting section and the recognition results of the character recognition section.

9. The image processing apparatus according to claim 7,
where the character recognition control section corrects a recognition result of a character image of the character recognition section on the basis of recognition results of character string images containing the same character image.

10. The image processing apparatus according to claim 7,
wherein the character recognition control section causes the character recognition section to use a character recognition result of a character image obtained by the character recognition section by recognizing a character string image, to recognize another character string image containing the same character image.

11. The image processing apparatus according to claim 7,
wherein the character recognition control section causes the character recognition section to recognize the character string images in ascending order of the number of unknown characters and to recognize other character string images on the basis of recognition results of character string images that have already been recognized.

12. A computer readable medium storing a program causing a computer to execute a process for character recognition, the process comprising:
accepting a document having pieces of character information and character images in mixture;
extracting the character images from the accepted document;
generating character string images each enclosed by spaces on the basis of positions, in the document, of the extracted character images or pieces of space information relating to spaces in the document;
recognizing character images;
recognizing generated character string images in order that is determined on the basis of occurrence frequencies of character image identification codes for unique identification of the extracted character images; and
shaping the document on the basis of the recognition.
